(19) United States
(12) Patent Application Publication
(10) Pub. No.: US 2026/0123578 A1
(43) Pub. Date: May 7, 2026

(54) GROUND SPEED AUTOMATION AND TERRAIN

(71) Applicant: Deere & Company, Moline, IL (US)

(72) Inventors: Nicholas C. BALTZ, Port Byron, IL (US); Cody W. BEST, Silvis, IL (US); Nathan R. VANDIKE, Geneseo, IL (US); Tucker J. SCHOFF, Princeton, IL (US); Tessa N. POTTEBAUM, Waukee, IA (US)

(21) Appl. No.: 18/934,955

(22) Filed: Nov. 1, 2024

(51) Int. Cl. A01D 41/127

(52) U.S. Cl. CPC A01D 41/127

(57) ABSTRACT

A system includes: one or more processors; and memory storing instructions, executable by the one or more processors. The instructions, when executed by the one or more processors configure the one or more processors to: obtain data indicative of a ride quality issue at an upcoming location at a worksite at which a work machine performs a current operation; identify a ride quality issue at the upcoming location at the worksite based on the data; and control the work machine based, at least, on the ride quality issue at the upcoming location at the worksite.

### FIELD OF THE DESCRIPTION

The present description relates to work machine operations. More specifically, the present description relates to perception sensor systems used in control of work machines, such as agricultural work machines.

### BACKGROUND

There are a wide variety of different types of work machines. Some such work machines include agricultural work machine, such as, but not limited to, agricultural harvesters (e.g., combine harvesters, etc.). As terrain over which a work machine travels during an operation varies, so too can the ride quality. Poor ride quality can affect machine operation as well as operator comfort.

The discussion above is merely provided for general background information and is not intended to be used as an aid in determining the scope of the claimed subject matter.

### SUMMARY

A system includes: one or more processors; and memory storing instructions, executable by the one or more processors. The instructions, when executed by the one or more processors configure the one or more processors to: obtain data indicative of a ride quality issue at an upcoming location at a worksite at which a work machine performs a current operation; identify a ride quality issue at the upcoming location at the worksite based on the data; and control the work machine based, at least, on the ride quality issue at the upcoming location at the worksite.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a partial pictorial, partial schematic illustration showing an example work machine in the form of an agricultural harvester.

FIG. 2 is a block diagram of one example system architecture.

FIG. 3 is a block diagram showing some examples of components of the system architecture, including dynamic perception monitoring system, in more detail.

FIG. 4 is a pictorial illustration showing one example of the operation of the system architecture.

FIG. 5 shows a flow diagram illustrating one example operation of the system architecture in performing proactive ride quality control.

FIG. 6 is a block diagram showing one example of items of a system architecture in communication with a remote server architecture.

FIGS. 7, 8, and 9 show examples of mobile devices that can be used in a system architecture.

FIG. 10 is a block diagram showing one example of a computing environment that can be used in a system architecture.

### DETAILED DESCRIPTION

For the purpose of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example can be combined with the features, components, and/or steps described with respect to other examples of the present disclosure.

As discussed above, ride comfort of a work machine can vary with terrain. For instance, ride comfort may be reduced when traveling over rougher terrain. Additionally, there is a general desire to complete worksite operations quickly. The rate at which a work machine completes a worksite operation is often tied directly to the travel speed of the work machine. Thus, in order to perform a worksite operation more quickly, it may be desirable to cause the work machine to travel more quickly. Increase in speed, along with terrain variance, may further reduce ride comfort. For example, ride comfort may be more greatly reduced when traveling over rough terrain at a higher speed than at a lower speed.

Ride comfort generally correlates with bouncing of the work machine (bouncing along the vertical axis (bouncing up and down), bouncing along the lateral axis (bouncing/swaying side-to-side), and bouncing along the longitudinal axis (bouncing/rocking back-and-forth). Change in characteristics of terrain (also referred to as change in terrain or terrain change) over which a work machine travels can affect (increase or decrease) the amount the work machine bounces and thus, the ride quality. Reduced ride quality can negatively impact operator comfort or negatively impact work machine performance (e.g., cause components (e.g., implements) of the machine to stray from a desired position set point, etc.).

In some examples, sensors on-board the work machine, such as observation sensors (e.g., cameras, lidar, radar, ultrasound, etc.), can be used to detect characteristics of the terrain (e.g., terrain features (e.g., rocks, ruts, washouts, holes, etc.), terrain profile (e.g., topography (e.g., elevation, slope, changes in slope and elevation), surface roughness, etc.), etc.) and the detected characteristics of the terrain can be used in the control of the work machine to improve ride quality. However, characteristics of the terrain can be difficult to detect during the course of a worksite operation, particularly on some worksites, such as agricultural work machines at which plants (e.g., crops and weeds) may occlude the view of the terrain. Additionally, given the travel speed of some work machines, it may be difficult to detect and react to characteristics in time to proactively control the work machine.

Disclosed herein are systems and methods that provide for proactive control of a work machine, such as an agricultural work machine, to improve ride quality in light of terrain variability. The systems and methods provide for obtaining data indicative of ride quality issues at locations ahead of the work machine (e.g., relative to a travel direction or route of the work machine) and for pro-actively controlling the work machine based on the data to improve ride quality (e.g., reduce the impact of terrain variance on ride quality). The data indicative of ride quality issues can include overhead imagery or maps of the worksite that indicate characteristics of the terrain of the worksite, sensor data (e.g., ride quality sensor data, from sensors on-board the work machine (e.g., sensor data generated as the machine travels over a proximate area of the worksite (e.g., adjacent pass, etc.), or sensor data from sensors on-board a different work machine that previously operated at the worksite. Thus, the system and methods disclosed herein provide for determination and execution of control settings for a work machine at a location at a worksite prior to the work machine reaching the location to improve ride quality.

It will be understood that while some examples herein proceed with reference to work machines in the form of agricultural work machines, such as agricultural harvesters, the systems and methods disclosed herein are applicable to and can be used with a wide variety of other types of work machines, including a wide variety of other types of agricultural work machines. For example, other types of agricultural work machines can include agricultural planters, agricultural sprayers, agricultural tillage machines, as well as various other agricultural work machines.

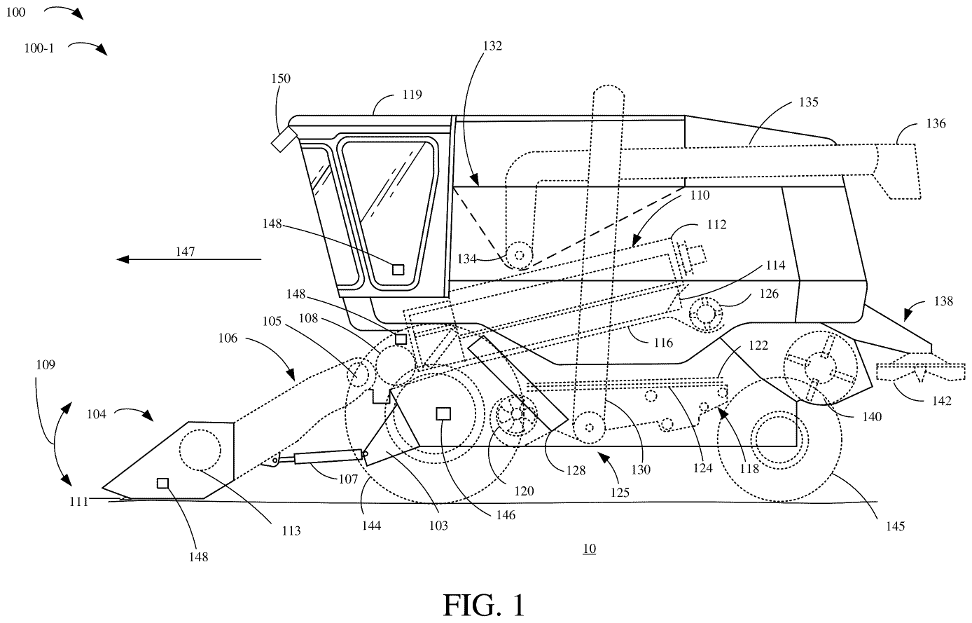

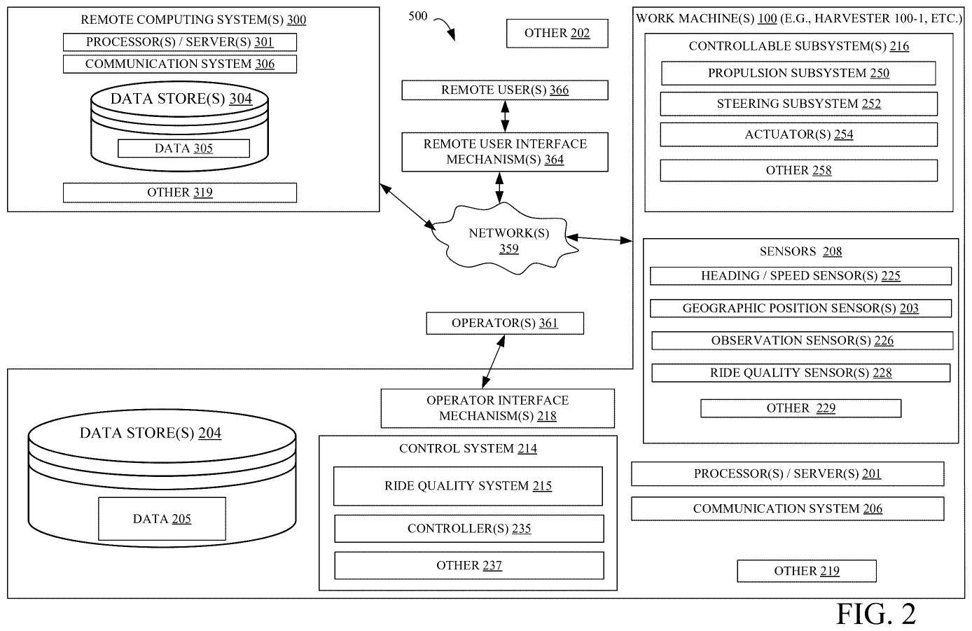

FIG. 1 is partial pictorial, partial schematic illustration of an example work machine 100 in the form of an agricultural work machine, specifically, an agricultural harvester 100-1. In the example shown in FIG. 1, agricultural harvester 100-1 is in the form of a combine harvester. As illustrated in FIG. 1, harvester 100-1 includes ground engaging traction elements (wheels or tracks) 144 and 145 which can be driven by a propulsion subsystem (e.g., internal combustion engine, electric motors, hydrostatic drive, and other drivetrain elements, such as a gear box) to propel harvester 100 across a worksite 10 (e.g., a field). Harvester 100-1 includes an operator compartment or cab 119, which can include a variety of different operator interface mechanisms (e.g., 218 shown in FIG. 2) for controlling harvester 100-1 as well as for presenting (e.g., displaying, etc.) various information. Harvester 100-1 includes a feeder house 106, a feed accelerator 108, and a thresher generally indicated at 110. The feeder house 106 and the feed accelerator 108 form part of a material handling subsystem 125. Header 104 is pivotally coupled to a frame 103 of harvester 100-1 along pivot axis 105. One or more actuators 107 drive movement of header 104 about axis 105 in the direction generally indicated by arrow 109. Thus, a vertical position of header 104 (the header height) above ground of the worksite 10 over which the header 104 travels is controllable by actuating actuator 107. While not shown in FIG. 1, agricultural harvester 100-1 can also include one or more actuators that operate to apply a tilt angle, a roll angle, or both to the header 104 or portions of header 104.

Material handling subsystem 125 further includes a thresher 110 which illustratively includes a threshing rotor 112 and a set of concaves 114. Further, material handling subsystem 125 also includes a separator 116. Agricultural harvester 100-1 also includes a cleaning subsystem or cleaning shoe (collectively referred to as cleaning subsystem 118) that includes cleaning fan(s) 120, chaffer 122, and sieve 124. The material handling subsystem 125 also includes discharge beater 126, tailings elevator 128, and clean grain elevator 130. The clean grain elevator moves clean grain into a material receptacle (or clean grain tank) 132.

Harvester 100-1 also includes a material transfer subsystem that includes a conveying mechanism 134 and a chute 135. Chute 135 includes a spout 136. In some examples, spout 136 can be movably coupled to chute 135 such that spout 136 can be controllably rotated to change the orientation of spout 136. Conveying mechanism 134 can be a variety of different types of conveying mechanisms, such as an auger, blower, or belted conveyor. Conveying mechanism 134 is in communication with clean grain tank 132 and is driven (e.g., by an actuator, such as motor or engine) to convey material from grain tank 132 through chute 135 and spout 136. Chute 135 is rotatable through a range of positions from a storage position (shown in FIG. 1) to a variety of deployed positions away from agricultural harvester 100-1 to align spout 136 relative to a material receptacle of a material receiving machine that is configured to receive the material within grain tank 132. Spout 136, in some examples, is also rotatable, by an actuator, to adjust the direction of the material stream exiting spout 136.

Harvester 100-1 also includes a residue subsystem 138 that can include chopper 140 and spreader 142.

In some examples, a harvester within the scope of the present disclosure can have more than one of any of the subsystems mentioned above. In some examples, harvester 100-1 can have left and right cleaning subsystems, separators, etc., which are not shown in FIG. 1.

In operation, and by way of overview, harvester 100-1 illustratively moves through a worksite (e.g., field) 10 in the direction indicated by arrow 147. As harvester 100-1 moves, header 104 engages the crop plants to be harvested and cuts, with a cutter bar 111 on the header 104, the crop plants to generate cut crop material.

The cut crop material is engaged by a cross conveyor (e.g. cross auger, belts, etc.) 113 which conveys the severed crop material to a center of the header 104 where the severed crop material is then moved through an opening to a conveyor in feeder house 106 toward feed accelerator 108, which accelerates the severed crop material into thresher 110. The severed crop material is threshed by rotor 112 rotating the crop against concaves 114. The threshed crop material is moved by a separator rotor in separator 116 where a portion of the residue is moved by discharge beater 126 toward the residue subsystem 138. The portion of residue transferred to the residue subsystem 138 is chopped by residue chopper 140 and spread on the field by spreader 142. In other configurations, the residue is released from the agricultural harvester 100-1 in a windrow.

Grain falls to cleaning subsystem 118. Chaffer 122 separates some larger pieces of material other than grain (MOG) from the grain, and sieve 124 separates some of finer pieces of MOG from the grain. The grain then falls to a conveyor (e.g., an auger, etc.) that moves the grain to an inlet end of grain elevator 130, and the grain elevator 130 moves the grain upwards, depositing the grain in grain tank 132. Residue is removed from the cleaning subsystem 118 by airflow generated by one or more cleaning fans 120. Cleaning fans 120 direct air along an airflow path upwardly through the sieves and chaffers. The airflow carries residue rearwardly in harvester 100-1 toward the residue handling subsystem 138.

Tailings elevator 128 returns tailings to thresher 110 where the tailings are re-threshed. Alternatively, the tailings also can be passed to a separate re-threshing mechanism by a tailings elevator or another transport device where the tailings are re-threshed as well.

Harvester 100-1 can include a variety of sensors, some of which are illustrated in FIG. 1, such as ground speed sensor 146, ride quality sensors 148, and observation sensors 150.

Ground speed sensor 146 senses the travel speed of harvester 100-1 over the ground. Ground speed sensor 146 can sense the travel speed of the harvester 100-1 by sensing the speed of rotation of the ground engaging traction elements 144 or 145, or both, a drive shaft, an axle, or other components. In some instances, the travel speed can be sensed using a positioning system, such as a global positioning system (GPS), a dead reckoning system, a long-range navigation (LORAN) system, a Doppler speed sensor, or a wide variety of other systems or sensors that provide an indication of travel speed. Ground speed sensors 146 can also include direction sensors such as a compass, a magnetometer, a gravimetric sensor, a gyroscope, GPS derivation, to determine the direction of travel in two or three dimensions in combination with the speed. This way, when harvester 100-1 is on a slope, the orientation of harvester 100-1 relative to the slope is known. For example, an orientation of harvester 100-1 could include ascending, descending or transversely travelling the slope.

Ride quality sensors 148 illustratively detect bouncing of harvester 100-1, including bouncing in multiple axes (e.g., three axes), such as a vertical axis of the harvester 100-1, a longitudinal axis of the harvester 100-1, and a lateral axis of the harvester 100-1. Ride quality sensors can detect motion or acceleration in these axes. Some examples of ride quality sensors 148 include accelerometers and inertial measurement units (IMUs). As illustrated in FIG. 1, a work machine 100, such as harvester 100-1, can include a plurality of ride quality sensors 148 mounted at different locations. For example, as shown, a work machine 100, such as harvester 100-1, can include a ride quality sensor 148 mounted to an implement/attachment (e.g., header 104), a ride quality sensor 148 attached to a frame/chassis (e.g., 103), and a ride quality sensor 148 mounted in an operator compartment (e.g., 119). These are merely some examples of mounting locations. It will be understood that ride quality sensors 148 can, additionally, or alternatively, be mounted at a variety of other locations.

Harvester 100-1 also includes one or more observation sensors. Some examples of observation sensors include image capture mechanisms, such as cameras, lidar sensors, radar sensors, and ultrasound (ultrasonic) sensors. Observation sensors 150 can detect characteristics, such as characteristics of the terrain (terrain characteristics) of the worksite 10, (e.g., terrain features (e.g., rocks, ruts, washouts, holes, etc.), terrain profile (e.g., topography (e.g., elevation, slope, changes in slope and elevation), surface roughness, etc.), as well as various other terrain characteristics. Observation sensors 150 can detect ahead of a work machine 100, such as harvester 100-1, relative a travel direction 147 or route.

While FIG. 1 shows an example mounting location of an observation sensor 150, it will be understood that observation sensors 150 can, alternatively, or additionally, be mounted at a variety of other locations on a work machine 100, such as harvester 100-1.

A work machine 100, such as harvester 100-1, as well as other work machines, can include various other sensors, some of which will be described in FIG. 2. A work machine 100, such as harvester 100-1, as well as other work machines, can include various other items, some of which will be described in FIG. 2.

FIG. 2 is a block diagram showing one example system architecture 500 (hereinafter also referred to as system 500). Where the work machine 100 comprises an agricultural work machine (e.g., harvester 100-1, etc.), system 500 can also be referred to as an agricultural system architecture (or agricultural system). System 500 includes one or more work machines 100. System 500 also includes one or more remote computing systems 300, one or more networks 359, one or more remote user interface mechanisms 364, and can include a variety of other items 202 as well.

Each work machine 100, itself, illustratively includes one or more processors or servers 201, one or more data stores 204, communication system 206, one or more sensors 208, control system 214, one or more controllable subsystems 216, one or more operator interface mechanisms 218, and can include various other items and functionality 219 as well.

Remote computing systems 300, as illustrated, include one or more processors or servers 301, one or more data stores 304, communication system 306, and can include various other items and functionality 319.

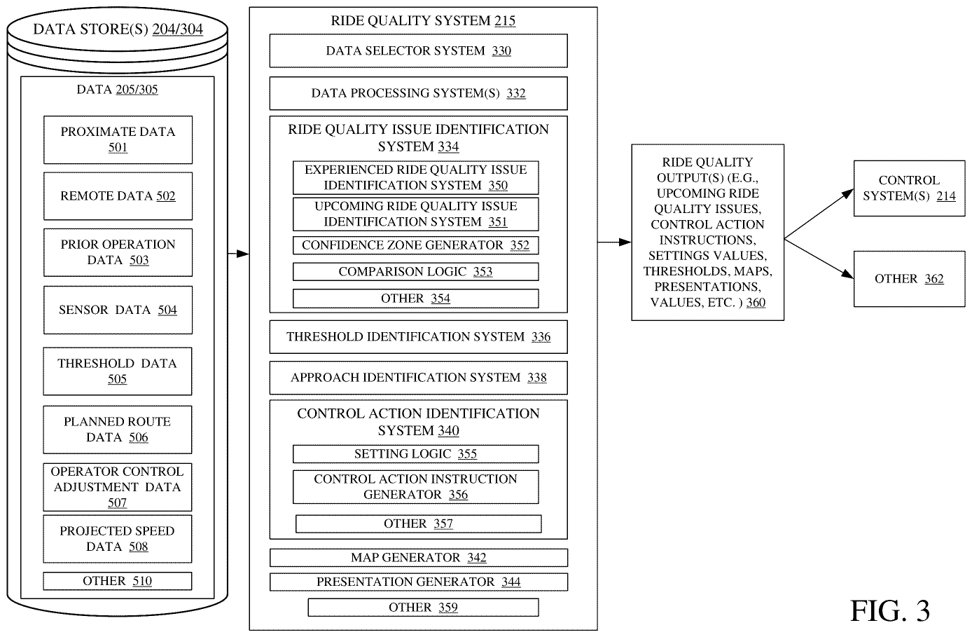

Data stores 204 and data stores 304 each store a variety of data (generally indicated as data 205 and data 305 respectively), some of which will be described in more detail herein. For example, data 205 or data 305, or a combination thereof, can include, among other things, proximate data, remote data, prior operation data, sensor data, threshold data, planned route data, operator control adjustment data, projected speed data, as well as various other data including, but not limited to, various other data described herein. Some examples of the various data will be described in more detail in FIG. 3. Additionally, data 205 can include computer executable instructions that are executable by one or more processors or servers 201 to implement other items or functionalities of system 500, including other items or functionalities of work machines 100. Additionally, data 305 can include computer executable instructions that are executable by one or more processors or servers 301 to implement other items or functionalities of system 500, including other items of remote computing systems 300. It will be understood that data stores 204 and data stores 304 can include different forms of data stores, for instance both volatile data stores (e.g., Random Access Memory (RAM)) and non-volatile data stores (e.g., Read Only Memory (ROM), hard drives, solid state drives, etc.).

Sensors 208 can include one or more heading/speed sensors 225, one or more geographic position sensors 203, one or more observation sensors 226, one or more ride quality sensors 228, and can include various other sensors 229 as well. The sensor data generated by sensors 208 can be communicated to remote computing systems 300 and to other work machines 100.

Control system 214, itself, can include one or more controllers 235 for controlling various other items of a work machine 100, ride quality system 215, and can include other items 237 as well. Controllable subsystems 216 can include propulsion subsystem 250, steering subsystem 252, actuators 254, and can include various other subsystems 258 as well.

Heading/speed sensors 225 detect a heading characteristic (e.g., travel direction) or speed characteristic (e.g., travel speed, change in travel speed, etc.), or both, of a work machine 100. This can include sensors that sense the movement (e.g., rotation) of ground-engaging elements (e.g., wheels or tracks) or movement of components coupled to the ground engaging elements (e.g., axles) or other elements, or can utilize signals received from other sources, such as geographic position sensors. Thus, while heading/speed sensors 225 as described herein are shown as separate from geographic position sensors 203, in some examples, machine heading/speed is derived from signals received from geographic position sensors 203 and subsequent processing. In other examples, heading/speed sensors 225 are separate sensors and do not utilize signals received from other sources. One example of heading/speed sensors 225 are sensors 146 shown in FIG. 1.

Geographic position sensors 203 illustratively sense or detect the geographic position or location of a work machine 100. Geographic position sensors 203 can include, but are not limited to, a global navigation satellite system (GNSS) receiver that receives signals from a GNSS satellite transmitter. Geographic position sensors 203 can also include a real-time kinematic (RTK) component that is configured to enhance the precision of position data derived from the GNSS signal. Geographic position sensors 203 can include a dead reckoning system, a cellular triangulation system, or any of a variety of other geographic position sensors.

Observation sensors 226 are operable to detect characteristics of the worksite, such as terrain characteristics, including at locations ahead of (relative to a travel direction or route of) a work machine 100. Some examples of observation sensors 226 include image capture mechanisms, such as cameras (e.g., mono cameras, stereo cameras, color (e.g. RGB) cameras, multispectral cameras, thermal cameras, infrared cameras, etc.), lidar sensors, radar sensor, and ultrasound (ultrasonic sensors). Observation sensors 226 generate sensor data (e.g., images, sensor signals, etc.) indicative of the detected characteristics (e.g., terrain characteristics). The sensor data generated by observation sensors 226 can be used in control of a work machine 100. One example of observation sensors 226 are observation sensors 150 shown in FIG. 1.

Ride quality sensors 228 are operable to detect bouncing of work machine 100, including bouncing in multiple axes (e.g., three axes), such as a vertical axis, a longitudinal axis, and a lateral axis of the work machine 100. Ride quality sensors 228 can detect motion or acceleration in these axes. Some examples of ride quality sensors 228 include accelerometers and inertial measurement units (IMUs). A work machine 100 can include one or more ride quality sensors 228. A work machine 100 can include a plurality of ride quality sensors 228 such as a plurality of ride quality sensors 228, each ride quality sensor 228 of the plurality disposed at a different location on the work machine 100. Ride quality sensors 228 generate sensor data indicative of ride quality of the work machine, such as sensor data indicative of bouncing of the work machine 100. The sensor data generated by ride quality sensors 228 can be used in the control of work machine 100. One example of ride quality sensors 228 are ride quality sensors 148 shown in FIG. 1.

Sensors 208 can also include various other types of sensors 229.

Control system 214 can include one or more controllers 235 (e.g., electronic control units, which can include or be implemented by one or more processors such as one or more processors 201) that generate control signals to control one or more components of a work machine 100 or components of system 500, or both. For example, but not by limitation, controllers 235 can include, a communication system controller to control communication system 206, an interface controller to control one or more interface mechanisms (e.g., 218 or 364, or both), a propulsion controller to control propulsion subsystem 250 to control a travel speed of a work machine 100, a path planning controller to control steering subsystem 252 to control a route or heading of a work machine 100, and one or more actuator controllers to control operation of actuators 254. In other examples, a central controller 235 can be used to generate control signals to control a plurality of the controllable subsystems 216 as well, in some examples, other items of a work machine 100 or system 500.

Propulsion subsystem 250 includes one or more controllable actuators (e.g., internal combustion engine, motors, pumps, gear boxes, etc.) that drive the ground engaging traction elements (e.g., wheels or tracks) of a work machine 100 to vary a travel speed of a work machine 100.

Steering subsystem 252 includes one or more controllable actuators (e.g., electric actuators, hydraulic actuators, etc.) that are controllably actuatable to control the steering and thus heading of a work machine 100.

Actuators 254 include a variety of different types of actuators that control operating parameters (e.g., pose (e.g., height, position, orientation), speed, spacing, etc.) of one or more components of a work machine 100. Actuators 254 can include actuators that control the position (e.g., height, depth, or spacing from another component of the machine or to the worksite) or orientation (e.g., pitch, roll, yaw, etc.) of components of a work machine 100 as well as actuators that control a speed of movement (e.g., speed of rotation, speed of reciprocation, etc.) of components of a work machine 100. Actuators 254 can include, without limitation, motors, valves, pumps, hydraulic actuators (e.g., hydraulic cylinders, etc.), pneumatic actuators (e.g., pneumatic cylinders, etc.), electro-mechanical actuators (e.g., linear actuators, etc.), as well as various other types of actuators. Where work machine 100 is an agricultural harvester 100-1, actuators 254 can include actuators controllable to control operating parameters of one or more of the components described in FIG. 1. Some example actuators 254 include actuators that set a position (e.g., height, depth, and/or orientation) of an attachment or implement of a work machine relative to the worksite surface. Some example actuators 254 include actuators that set or provide a biasing force (e.g., lifting force or downforce) that bias an attachment towards or away from the worksite surface.

FIG. 2 also shows that control system 214 can include ride quality system 215. Ride quality system 215 is operable to identify ride quality issues and to generate action outputs useable to proactively control a work machine to improve ride quality. Ride quality system 215 will be discussed in more detail in FIG. 3.

Communication system 206 is used to communicate between components of a work machine 100 or with other items of system 500, such as remote computing systems 300, other work machines 100, or user interface mechanisms 364, or a combination thereof. Communication system 306 is used to communicate between components of a remote computing system 300 or with other items of system 500, such as work machines 100, other remote computing systems 300, or user interface mechanisms 364, or a combination thereof.

Communication systems 206 and 306 can each include one or more of wired communication circuitry and wireless communication circuitry, as well as wired and wireless communication components. In some examples, communication systems 206 and 306 can each be a system for communicating over the Internet, a cellular communication system, a system for communicating over a wide area network or a local area network, a system for communicating over a controller area network (CAN), such as a CAN bus, a system for communicating over a controller area network flexible data-rate (CAN-FD), such as a CAN-FD bus, a system for communication over a near field communication network, a system for communicating over ethernet, or a communication system configured to communicate over any of a variety of other networks. Communication systems 206 and 306 can each also include a system that facilitates downloads or transfers of information to and from a secure digital (SD) card or a universal serial bus (USB) card, or both. Communication systems 206 and 306 can each utilize network 359. Networks 359 can be any of a wide variety of different types of networks such as the Internet, a cellular network, a wide area network (WAN), a local area network (LAN), a controller area network (CAN), a controller area network flexible data-rate (CAN-FD), a near-field communication network, ethernet, or any of a wide variety of other networks.

FIG. 2 shows that one or more operators 361 can operate work machines 100. The operators 361 interact with operator interface mechanisms 218. In some examples, operator interface mechanisms 218 can include joysticks, levers, a steering wheel, linkages, pedals, buttons, wireless devices (e.g., mobile computing devices, etc.), dials, keypads, a display device (including a display screen), user actuatable elements (such as icons, buttons, etc.) on a display device, a microphone and speaker (where speech recognition and speech synthesis are provided), among a wide variety of other types of control devices. Where a touch sensitive display system is provided, the operators 361 can interact with operator interface mechanisms 218 using touch gestures. Additionally, at least some of the operator interface mechanisms 218 can be used to present (e.g., display, audible presentation, haptic presentation, etc.) various information. The examples described above are provided as illustrative examples and are not intended to limit the scope of the present disclosure. Consequently, other types of operator interface mechanisms 218 can be used and are within the scope of the present disclosure.

FIG. 2 also shows remote users 366 interacting with work machines 100 and remote computing systems 300 through user interface mechanisms 364 over networks 359. In some examples, user interface mechanisms 364 can include joysticks, levers, a steering wheel, linkages, pedals, buttons, wireless devices (e.g., mobile computing devices, etc.), dials, keypads, a display device (including a display screen), user actuatable elements (such as icons, buttons, etc.) on a display device, a microphone and speaker (where speech recognition and speech synthesis are provided), among a wide variety of other types of control devices. Where a touch sensitive display system is provided, the users 366 can interact with user interface mechanisms 364 using touch gestures. Additionally, at least some of the user interface mechanisms 364 can be used to present (e.g., display, audible presentation, haptic presentation, etc.) various information. The examples described above are provided as illustrative examples and are not intended to limit the scope of the present disclosure. Consequently, other types of user interface mechanisms 364 can be used and are within the scope of the present disclosure.

Remote computing systems 300 can be a wide variety of different types of systems, or combinations thereof. For example, remote computing systems 300 can be in a remote server environment. Further, remote computing systems 300 can be remote computing systems, such as mobile devices, a remote network, a farm manager system, a vendor system, or a wide variety of other remote systems. In one example, work machines 100 can be controlled remotely by remote computing systems 300 or by remote users 366, or both. In some examples, operators 361 are on-board (e.g., in an operator compartment, such as a cab) the work machines 100. In some examples, operators 361 are remote from the work machines 100 and control the work machines 100 through one or more interface mechanisms (e.g. one or more of 218) which are remote from the machines but operatively coupled (e.g., communicatively coupled, such as over networks 359) to the machines.

It will be understood that, in some examples, items in system 500 can be distributed in various ways, including ways that differ from the example shown in FIG. 2. For example, but not by limitation, ride quality system 215, shown in FIG. 2 as being disposed on work machines 100, can be located elsewhere, such as at one or more remote computing systems 300. In yet other examples, ride quality system 215 can be distributed across a work machine 100 and a remote computing system 300.

FIG. 3 is a block diagram that shows examples of some of the components of system 500 in more detail and information flow between the components.

As illustrated in FIG. 3, it can be seen that data stores 204 or data stores 304, or a combination thereof, can include as data (205 and 305, respectively), proximate data 501, remote data 502, prior operation data 503, sensor data 504, threshold data 505, planned route data 506, operator control adjustment data 507, projected speed data 508, and can include various other data 510, including, but not limited to, other data described elsewhere herein. In some examples, where the data is located can depend on where ride quality system 215 (also called system 215) is located.

As shown in FIG. 3, system 215 includes data selector system 330, one or more data processing systems 332, ride quality issue identification system 334, threshold identification system 336, approach identification system 338, control action identification system 340, map generator 342, presentation generator 334, as well as various other items and functionality 359. As will be described in more detail, system 215 is operable to generate one or more outputs 360. Ride quality issue identification system 334, itself, includes experienced ride quality issue identification system 350, upcoming ride quality issue identification system 351, confidence zone generator 352, comparison logic 353, and can include various other items and functionality 354. Control action identification system 340, itself, can include setting logic 355, control action instruction generator 356, and can include various other items and functionality 357.

Proximate data 501 includes data indicative of ride quality issues at locations proximate to an upcoming location for which proactive control is to be undertaken. For example, proximate data 501 can include data indicative of ride quality issues at a first location at the worksite (currently being or already traveled by a work machine 100 in a current operation (e.g., harvested location, etc.)), proximate to a second location (not yet traveled by the work machine 100 in the current operation (e.g., unharvested location)) for which proactive control is to be undertaken (i.e., the work machine 100 is to be proactively, prior to reaching the second location). Proximate, as used herein with regard to proximate data (or with regard to locations proximate to upcoming locations), refers to a spatial relationship between locations such that a ride quality issue at a first location is likely to persist (or exist) at a second location given their proximity. The first and second locations can be in the same pass (e.g., harvesting pass) or in adjacent passes. An adjacent pass can be immediately next to the current pass or can be separated from a current pass by one or more intermediate passes. A pass generally corresponds to a working width of the work machine (e.g., width of attachment or implement, such as header 104) and generally constitutes a traveled path from one end of the field to an opposite end of the field (e.g., between opposite headlands of an agricultural field). Proximate data 501 can include ride quality sensor data generated by ride quality sensors 228 indicative of bouncing of a work machine 100 or speed sensor data generated by heading/speed sensors 225, indicative of machine travel speed (or change therein - such as acceleration or deceleration) of a work machine 100, or both, corresponding to locations proximate to an upcoming location. For instance, a ride quality issue detected at a first location may be used to predict a ride quality issue at an upcoming, second location. Additionally, a change in machine travel speed (e.g., a deceleration) detected at a first location may be used to predict a ride quality issue at an upcoming, second location. Proximate data 501 can include observation sensor data generated by observation sensors 226 indicative of terrain characteristics corresponding to locations proximate to an upcoming location. For instance, a terrain characteristic detected at a first location may be used to predict a ride quality issue at an upcoming location.

Remote data 502 includes data indicative of terrain characteristics of a worksite (at which a work machine is to or is operating) collected by systems remote from the worksite, such as satellites or fly-over machine (e.g., drones, planes, etc.). Remote data 502 can include overhead images or other sensor data generated by sensors on remote systems. Remote data 502 can be in the forms of maps of the worksite that indicate terrain characteristics at different locations across the worksite.

Prior operation data 503 includes data generated during or derived from a prior operation at a worksite (at which a work machine is to or is operating), such as sensor data indicative of ride quality issues generated by sensors on a work machine 100 during a prior operation at the worksite or sensor data indicative of terrain characteristics of the worksite generated by sensors on a work machine during a prior operation at the worksite. In some examples, the prior operation data 503 can be in the form of a map of the worksite that indicates terrain characteristics or ride quality issues at different locations across the worksite as detected during the prior operation. In some examples, prior operation data can be generated by a different machine or a same machine as the work machine 100 in a current operation. For example, for a current or upcoming operation, a first work machine 100 may be currently operating or set to operate at the worksite and the prior operation data 503 could have been generated by the first work machine 100 during a prior operation at the worksite.

In another example, for a current or upcoming operation, a first work machine 100 may be currently operating or set to operate at the worksite and the prior operation data 503 could have been generated by as second work machine 100, different than the first work machine 100, during a prior operation at the worksite. The second work machine can be of a same machine type as the first work machine (e.g., both are harvesters (e.g., 100-1)). The second work machine can be of a different machine type than the first work machine (e.g., second work machine 100 is one of a planter, a sprayer, a tillage machine, or a harvester and the first work machine 100 is a different one of a planter, a sprayer, a tillage machine, or a harvester). In such examples (second work machine of a different machine type), the second work machine 100 also performs a different type of operation than the first work machine 100.

It will be understood that prior operation data 503 can include data from multiple prior operations at a worksite from a plurality of different work machines 100.

Sensor data 504 includes sensor data generated by sensors 208 other than ride quality sensor data generated by ride quality sensors 228, observation sensor data generated by observation sensors 226, and speed sensor data generated by heading/speed sensor data 225. Thus, sensor data 504 includes geographic position sensor data generated by geographic position sensors 203, heading sensor data generated by heading/speed sensors 225, and other sensor data generated by other sensors 229.

Threshold data 505 include threshold values, such as ride quality (or bouncing) threshold values, machine speed (e.g., travel speed, travel speed change (e.g., deceleration), etc.) threshold values, and terrain characteristic threshold values. It will be understood that in some examples, threshold values can be a range of values. Threshold values can be provided by an operator or user (e.g., input into an interface mechanism), can be provided by a manufacturer or other third-party (e.g., service provider), can be programmed into a work machine 100, or, as will be described later, can be generated by system 215. A ride quality (or bouncing) value (and thus ride quality (or bouncing) threshold value) is a value describing an acceleration (or bouncing) of the work machine in an axis (e.g., a vertical, lateral, or longitudinal axis of the work machine 100) and is detectable by ride quality sensors 228. A machine speed value (and thus machine speed threshold value) is a value describing a travel speed (e.g., miles per hour, kilometers per hour, meters per second, etc.) or a change in travel speed (e.g., deceleration) of the work machine 100. A terrain characteristic value (and thus terrain characteristic value) is a value corresponding to a terrain characteristic. In some examples, terrain characteristic values can be binary values (e.g., yes/no, 0/1, etc.) that indicate presence of a terrain characteristic, such as a terrain feature. In some examples, terrain characteristic values may be categorical to indicate a type (or sub-type) of terrain characteristic, such as unique values for each of a plurality of different terrain features. In some examples, terrain characteristic values can be numerical values describing terrain profile, such as numerical values describing topography (e.g., elevation, slope, change in slope, change in elevation) or surface roughness.

It will be understood that the term exceeding with reference to a value exceeding a threshold value, as used herein, does not mean, in every example, that the value is greater than the threshold value. Rather, it will be understood that exceeding means that the value does not satisfy the threshold value, which can, in some examples, mean that the value is less than the threshold value or, in other examples, can mean that the value is greater than the threshold value. Also, in some examples, a threshold value can be a range of values and thus, exceeding, means that the value does not satisfy the threshold value range (e.g., is outside of the range, whether higher or lower).

Planned route data 506 includes data indicative of a planned route of a work machine 100 for a current or upcoming operation. Planned route data 506 can be provided by an operator or user, or provided in other ways (e.g., output from control system 214).

Operator control adjustment data 507 includes data indicative of operator adjustments to machine settings. This can include data indicative of interaction with (e.g., movement, settings value inputs, etc.) one or more interface mechanisms 218 used by the operator to adjust settings of the machine. Such interaction can, in some examples, be detected by sensors (e.g., 229) that detect movement of interface mechanisms 218 or detect values input into interface mechanisms 218.

Projected speed data 508 includes data indicative of projected (e.g., planned, prescribed, predicted) speeds (e.g., travel speed) of the work machine 100 at different locations at the worksite, including upcoming locations. In some examples, the projected speeds may be based on a plan or prescription (e.g., a speed control map for the worksite, a setting, etc.). In some examples, the projected speeds may be predicted by the system 500 based on travel speed during the course of the operation as well as other characteristics corresponding to the worksite.

Data selector system 330 is operable to select data to be used by system 215 in identifying ride quality issues and implementing proactive control to improve ride quality.

For example, where remote data 502 includes separate data, data selector system 330 can select one of the data based on criteria. For instance, data selector system 332 may be configured to select the remote data 502 that was generated closest in time to the current or upcoming operation, or may prefer remote data generated at a time when the worksite would have been substantively bare (e.g., post tillage and prior to vegetation emergence post planting). In another example, remote data 502 may include separate data from different remote systems and data selector 332 may be configured to prefer (and thus select) remote data generated by one type of remote system over remote data generated by another type of remote system.

In other examples, where prior operation data 503 includes separate data, data selector system 330 can select one of the data based on criteria. For instance, data selector system 330 may be configured to select the prior operation data 503 from a prior operation that is closest in time to the current or upcoming operation. In another example, data selector system 330 may be configured to select the prior operation data 503 based on machine type of the machine performing the prior operations. For instance, data selector system 330 may be configured to prefer (and thus select) prior operation data 503 generated by the same machine or a machine of the same type as the work machine 100 performing a current operation. Where the machine types are different than the work machine 100 performing the current operation, data selector system 330 may be configured to prefer (and thus select) prior operation data 503 generated by one different type of machine than another different type of machine.

Data processing systems 332 process data 205/305 (including data selected by data selector system 330) to extract or generate computer readable values usable by other items of system 215 (and system 500). Data processing system 332 can include various processors or processing functionality, including image processing functionality, sensor signal processing functionality, filtering processing functionality, categorization processing functionality, normalization processing functionality, aggregation processing functionality, color extraction processing functionality, analog-to-digital conversion processing functionality, other conversion processing functionality (e.g., look up tables, equations, mathematical functions, models, etc.), as well as various other data processing functionalities.

It will be understood then that data processing systems 332 can, for example, convert analog signals to readable digital signals (or digital values). It will be understood that data processing systems 332 can, for example, process images, sensor signals, maps, tables, input values, as well as various other data indicating values, to extract values, and can further convert the extracted values. It will be understood that data processing systems 332 can perform pre-processing and post-processing. It will be understood that data processing systems 332 can perform various forms of aggregation on the extracted or converted values.

Ride quality issue identification system 334 is operable to identify ride quality issues corresponding to the worksite. A ride quality issue can be identified by ride quality issue identification system 334 based on a comparison of a data value indicative of a ride quality issue to a corresponding threshold value. A data value indicative of a ride quality issue can be a ride quality value (e.g., a ride quality value detected by ride quality sensors 228 (e.g., provided in proximate data 501) or provided in prior operation data 503). A data value indicative of a ride quality issue can be a machine speed value (e.g., a machine speed value detected by heading/speed sensors 225 (e.g., provided by proximate data 501) or provided in prior operation data 502). A data value indicative of a ride quality issue can be a terrain characteristic value (e.g., a terrain characteristic value detected by observation sensors 226 (e.g., provided in proximate data 501) or provided in remote data 502 or provided in prior operation data 503). Comparison logic 353 is operable to compare a data value indicative of a ride quality issue to a corresponding threshold value and generate an output indicative of the comparison.

Experienced ride quality issue identification system 350 is operable to identify ride quality issues experienced by a work machine 100 at a worksite. For example, experienced ride quality issue identification system 350 can identify ride quality issues experienced by a work machine based on a ride quality value (e.g., detected by ride quality sensors 228). For instance, based on a comparison of a ride quality value to a corresponding ride quality threshold value, which can be executed and output by comparison logic 353.

Upcoming ride quality issue identification system 351 identifies ride quality issues for upcoming (not yet operated at during the current operation (e.g., unharvested, etc.)) locations at a worksite based on one or more items of data 205/305 and/or outputs of other items of system 215.

Upcoming ride quality issue identification system 351 can identify ride quality issues at upcoming locations based on values (e.g., terrain characteristic values) as provided in remote data 502 at those upcoming locations. In some examples, this can include a comparison of the values (e.g., terrain characteristic values) to corresponding threshold values (e.g., terrain characteristic threshold values) as executed and output by comparison logic 353. For example, where remote data 502 indicates a value (e.g., terrain characteristic value) of a given level (e.g., a terrain characteristic value exceeding a corresponding threshold) at an upcoming location, upcoming ride quality issue identification system 351 can identify a ride quality issue at that upcoming location.

Upcoming ride quality issue identification system 351 can identify ride quality issues at upcoming locations based on values (e.g., terrain characteristic values, ride quality values, machine speed values) as provided in prior operation data 503 at those upcoming locations. In some examples, this can include a comparison of the values (e.g., terrain characteristic values, ride quality values, machine speed values) to corresponding threshold values (e.g., terrain characteristic threshold values, ride quality threshold values, machine speed threshold values) as executed and output by comparison logic 353. For example, where prior operation data 503 indicates a value (e.g., terrain characteristic value, ride quality value, machine speed value) of a given level (e.g., a terrain characteristic value exceeding a corresponding threshold, a ride quality value exceeding a corresponding threshold, a machine speed value exceeding a corresponding threshold) at an upcoming location, upcoming ride quality issue identification system 351 can identify a ride quality issue at that upcoming location.

Upcoming ride quality issue identification system 351 can identify ride quality issues at upcoming locations based on terrain characteristic values (e.g., terrain characteristic values as provided by proximate data 501, remote data 502, or prior operation data 503) as well as projected machine speed values corresponding to the upcoming locations as provided by projected speed data 508. For example, based on a terrain characteristic value (corresponding to an upcoming location or at a location proximate to the upcoming location) and a projected machine speed value corresponding to the upcoming location, ride quality issue identification system 351 can identify a ride quality issue at the upcoming location.

Upcoming ride quality issue identification system 351 can identify ride quality issues at upcoming locations based on values (e.g., terrain characteristic values, ride quality values, machine speed values) as provided in proximate data 501 at locations of the worksite proximate to the upcoming locations. As previously discussed, proximate, as used herein with reference to proximate data or with reference to locations proximate to upcoming locations, refers to a spatial relationship between locations. That is, a spatial relationship between a second location (upcoming location) and a first location (current or already operated upon location)) such that a ride quality issue at a first location is likely to be relevant to the second location (e.g., the ride quality issue at the first location is likely to persist or exist at the second location). This is because a terrain feature that causes a ride quality issue at a first location may also be present at a second location. As previously explained, the first and second locations can be in the same pass or in adjacent passes.

In some examples, this can include a comparison of the values (e.g., terrain characteristic values, ride quality values, machine speed values) at the proximate locations to corresponding threshold values (e.g., terrain characteristic threshold values, ride quality threshold values, machine speed threshold values) as executed and output by comparison logic 353. For example, where proximate data 503 indicates a value (e.g., terrain characteristic value, ride quality value, machine speed value) of a given level (e.g., a terrain characteristic value exceeding a corresponding threshold, a ride quality value exceeding a corresponding threshold, a machine speed value exceeding a corresponding threshold) at a first location, upcoming ride quality issue identification system 351 can identify a ride quality issue at a second, upcoming, location that is proximate (has a spatial relationship) to the first location.

Thus, in some examples, upcoming ride quality issue identification system 351 projects (or predicts) a pathway of a terrain characteristic, or at least, predicts that a terrain characteristic at a first location will also be at a second location. Terrain characteristics may not proceed across the worksite in a uniform manner, such as in a uniform footprint or in a uniform direction. Thus, it may not be sufficient to simply translate a terrain characteristic from a first location to a second location along a straight line, such as along the same latitude or longitude. For example, the second location of a terrain characteristic may be offset from the first location in multiple directions. Upcoming ride quality issue identification system 351 can utilize sensor data, such as sensor data generated by observation sensors 226, to identify and predict a trajectory of the terrain characteristic, when available. Upcoming ride quality issue identification system 351 can utilize a combination of different items of data 205/305 to identify and predict a trajectory of the terrain characteristic, such as a combination of proximate data 501, remote data 502, prior operation data 503. and sensor data 504. However, system 215 also, to account for error, can establish confidence zones (or bands), as is described below.

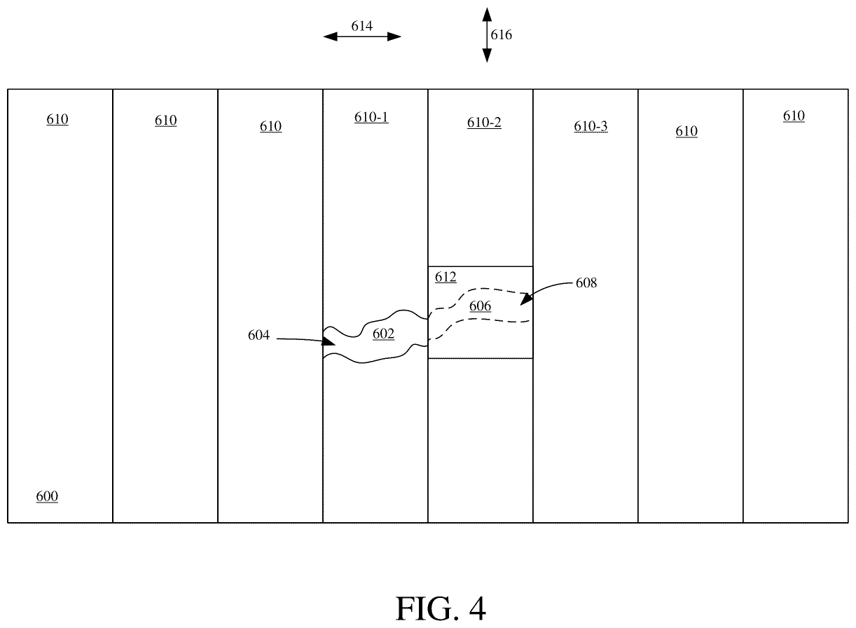

Confidence zone generator 352 is operable to identify confidence zones (or bands) around upcoming locations. The confidence zones (or bands) act to indicate a wider area of the worksite at which an upcoming ride quality issue could exist and thus, accounts for error in prediction of upcoming ride quality issues. For instance, it is understood that a terrain characteristic may not have a straight or uniform pathway across a worksite and thus, when upcoming ride quality issue identification system 351 predicts a location of an upcoming ride quality issue (such as by projecting a pathway of a terrain characteristic from a proximate location), confidence zone generator 352 is operable to identify confidence zones (or bands) around the predicted location of the upcoming ride quality issue. In some examples, it may be that the work machine 100 is controlled relative to a confidence zone, rather than just relative to the predicted location of the upcoming ride quality issue. Whether a confidence zone is generated or the size of the confidence zone can depend on confidence criteria, such as the quality of the data indicating the ride quality issue, machine characteristics (e.g., type of machine, type of operation, machine settings (e.g., travel speed), and the type of terrain characteristic (e.g., may be more confident in projecting the pathway of a rut as compared to a washout for example). An example of a confidence zone is shown in FIG. 4.

Threshold identification system 336 is operable to identify new or adjusted threshold values based on one or more items of data 205/305, such as, but not limited to, operator control adjustment data 507. For instance, when an operator 361 of a work machine 100 changes settings of the work machine 100 (e.g., change travel speed, change lifting force or position settings for attachment/implement, etc.) threshold identification system 336 can determine that a new or adjusted threshold value is needed (i.e., the current threshold value did not result in automatic control adjustment and instead the operator had to institute control adjustment). For instance, it may be, in such cases, that a ride quality threshold value, a machine speed threshold value, or a terrain characteristic threshold value needs to be adjusted to ensure that machine setting adjustment will occur (as desired by an operator) without the need for manual adjustment by the operator.

Approach identification system 338 is operable to identify an approach angle of a work machine 100 relative to a terrain characteristic at an upcoming location at the worksite based on, for instance, a planned route of planned route data 506 or based on heading sensor data generated by heading/speed sensors 225 (provided in sensor data 504). The angle at which a work machine 100 approaches a terrain characteristic can impact the resulting control to account for the terrain characteristic. For instance, it may be that the work machine 100 can travel across an upcoming location (having the terrain characteristic) when approaching from a first approach angle as compared to when approaching from a second approach angle. Additionally, it may be that the planned route or heading of the work machine 100 may need to be altered when approaching from a first approach angle whereas the planned route or heading of the work machine 100 would not need to be changed when approaching from a second approach angle. Similarly, the approach angle may impact resulting control of actuators 254, for instance, how and if a position setting or lifting force setting for an attachment/implement (e.g., header 104) can be impacted based on an approach angle of the work machine relative to an upcoming location (having the terrain characteristic).

Map generator 342 is operable to generate maps of the worksite that include information identified or detected during a current operation, such as terrain characteristics, ride quality values, ride quality issues, machine speed values, confidence zones, as well as various other information. The information can be populated in the map such that the information is located, in the map, at a geographic location corresponding to the geographic location in the worksite at which the information was detected or for which the information was identified.

Presentation generator system 344 is operable to generate one or more presentations (e.g., display, audible, haptic etc.) for presentation (e.g., display, audible presentation, haptic presentation, etc.) on one or more interface mechanisms (e.g., one or more of 218 or 364). The presentations can, for example, alert an operator about an upcoming ride quality issue, provide a recommendation to an operator for machine control adjustment to improve ride quality, present a map generated by map generator 342, as well as various other information. In one example, presentation generator 344 is operable to generate a presentation that prompts operator or user feedback (e.g., approval or disapproval) of an output, such as approval or disapproval of a threshold identified by threshold identification system 336 or such as approval or disapproval of an output of control action identification system 340.

Control action identification system 340 is operable to identify machine settings and to output corresponding control action instructions to institute the identified machine settings to improve ride quality (e.g., to address ride quality issues at upcoming locations). Setting logic 355 is operable to identify one or more machine settings to improve ride quality based on upcoming ride quality issues identified by upcoming ride quality issue identification system 351, as well, as one or more items of data 205/305.

In some examples, setting logic 355 may identify a machine setting that matches a machine setting from the data 205/305. For instance, prior operation data 503 may provide machine settings that were instituted in a prior operation at the location and setting logic 355 may identify matching machine settings for the current operation for the location (upcoming location). Thus, if, for example, in the prior operation, a work machine 100 decelerated to 2 miles per hour, then, setting logic 355 may identify as a machine setting for the current operation, a travel speed of 2 miles per hour. A matching machine setting is particularly applicable where the prior operation data 503 is derived from the same work machine 100 that is being used in the current operation or when the work machine 100 in the prior operation is of the same type (e.g., harvester 100-1, etc.) as the work machine 100 in the current operation.

In some examples, setting logic 355 may identified a scaled machine setting based on a machine setting from the data 205/305. For instance, prior operation data 503 may provide machine settings that were instituted in a prior operation at the location and setting logic 355 may identify scaled machine settings for the current operation for the location (upcoming location). A scaled machine setting is particularly applicable where the prior operation data 503 is derived from a work machine 100 that is of a different machine type than the work machine 100 in the current operation. For example, planters and spraying machines generally travel at higher speeds than harvesters. Thus, a speed setting for a planter or a sprayer may not make sense for a harvester. For instance, if a planter or sprayer reduced from 10 miles per hour to 5 miles per hour, matching 5 miles per hour for the harvester would not suit as harvesters may generally travel at 3 miles per hour. Thus, instead, machine setting logic 355 may identify a scaled machine setting. Keeping with the above example, since the planter or sprayer reduced speed by half, the scaled machine setting may cause the harvester to reduce speed by half (i.e., reduce from 3 miles per hours to 1.5 miles per hour) or by some other proportion (i.e., reduce from 3 miles per hour to 2 miles per hour).

Where prior operation machine setting values are not available, setting logic 355 may instead be programmed to identify machine settings in other ways, such as by pre-set adjustment values or based on learning functionality. For example, setting logic 355 may identify a machine setting value for an upcoming location and then monitor ride quality (e.g., as detected by ride quality sensors 228) or further operator adjustment (as provided by operator control adjustment data 507) corresponding to the location to learn the effectiveness of the identified machine setting value. This continued learning can be used in the identification of future machine settings.

Control action instruction generator 356 is operable to generate control action instructions based on machine settings identified by setting logic 355. The control action instructions define the machine setting as well as other information (e.g., timing) and are provided to and useable by controllers 235 to control one or more corresponding controllable subsystems 216 to institute the machine setting (at the correct time). Control action instruction generator 356 can also generate the control action instructions based on various other data 205/305, for instance geographic position sensor data (from sensors 203) indicative of geographic position of the work machine 100, speed data (e.g., speed sensor data (from sensors 225 indicative of a current speed of the work machine 100), predicted speed data from projected data 508, etc.), and heading sensor data (from sensors 225) or planned route data 503 indicative of a heading or route of the work machine 100, in order to instruct proper timing of the control action (i.e., such that the machine setting is adjusted as desired with correct timing given when the work machine 100 will arrive at the upcoming location).

It can be seen that system 215 is operable to generate one or more ride quality outputs 360 (hereinafter also referred to as output/outputs 360). An output 360 can include one or more upcoming ride quality issues identified by upcoming ride quality issue identification system 351, control action instructions generated by control action instruction generator 356, machine settings values identified by setting logic 355, thresholds identified by threshold identification system 336, maps generated by map generator 342, presentations generated by presentation generator 344, or values indicated by data 205/305 or extracted by data processing system 332 (e.g., ride quality values, terrain characteristic values, machine speed values, etc.), as well other information of data 205/305 or generated or identified by system 215. An output 360 can be used in the control of a work machine 100. For example, an output 360 can be obtained (e.g., retrieved or received) by one or more control systems 214 to control a work machine 100, such as by controlling one or more controllable subsystems 216 or one or more interface mechanisms 218 (e.g., to present (e.g., display, etc.) information of (or based on) the output 360), or both. Additionally, or alternatively, an output 360 can be obtained (e.g., retrieved or received) by various other items and used in various other ways. For example, but not by limitation, a harvesting logistics output 360 can be obtained (e.g., retrieved or received) by one or more other items 362, such as one or more interface mechanisms 364 (e.g., to present (e.g., display, etc.) information of (or based on) the output 360).

FIG. 4 is a pictorial illustration showing one example of the operation of system 500. FIG. 4 shows a field 600, an experienced ride quality issue 602 corresponding to a first location 604, an upcoming ride quality issue 606 corresponding to a second location 608, and a confidence zone (or band) 612. Field 600 includes a plurality of passes 610.

As can be seen, in the illustrated example, an experienced ride quality issue 602 was identified corresponding to a first location 604 in a first pass 610-1 at the worksite. System 215 (e.g., experienced ride quality issue identification system 350) identified the experienced ride quality issue based on sensor data generated by a work machine as it operated in the first pass 610-1 (e.g., as provided in proximate data 501). Based on the identified experienced ride quality issue 602 (or the data indicative thereof) system 214 (e.g., upcoming ride quality issue identification system 351) identifies an upcoming ride quality issue 606 at a second location 608 in a second (adjacent) pass 610-2. The second pass 610-2 as illustrated in FIG. 4 is immediately adjacent to the first pass 610-1, however, this need not be the case, instead, system 215 could identify an upcoming ride quality issue in another pass (based on data corresponding to the first pass 610-1), such as in pass 610-3 which is not immediately adjacent to the first pass 610-1. As can be seen, the predicted location of the upcoming ride quality issue 606 is offset from the experienced ride quality issue 602 in both a first direction 614 and a second direction 616. Additionally, system 215 (e.g., confidence zone generator 352) generates a confidence zone 612 that indicates an area of the worksite in which system 215 deems it likely (above a certain threshold) that a ride quality issue could exist to account for error in the prediction of the location of the upcoming ride quality issues 606.

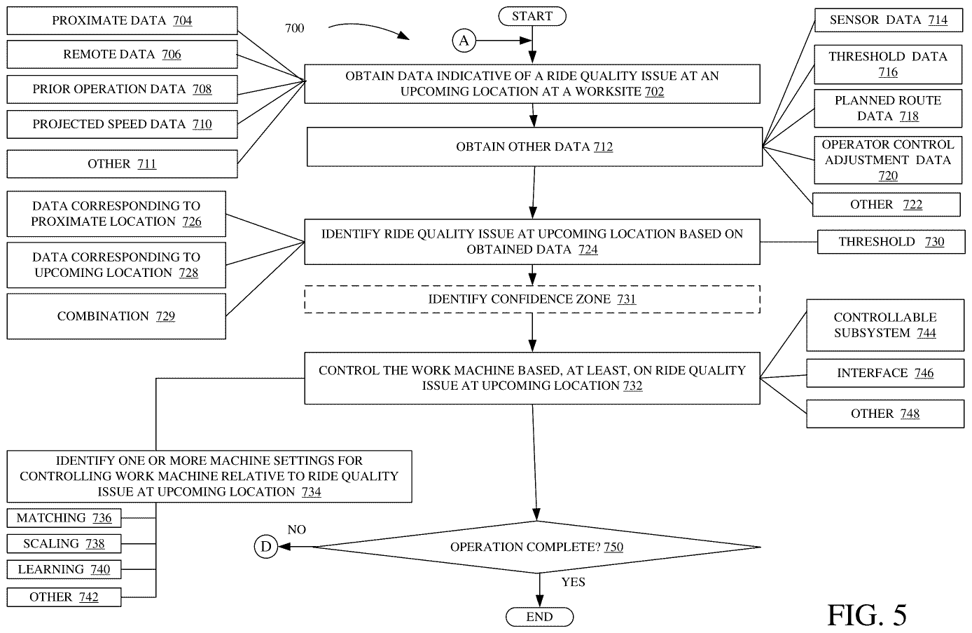

FIG. 5 shows a flow diagram illustrating an example operation 700 of system 500 (e.g., ride quality system 215) in performing proactive ride quality control.

At block 702, one or more items of data indicative of a ride quality issue at an upcoming location at a worksite are obtained (e.g., retrieved or received) by system 500 (e.g., ride quality system 215). The obtained data can include proximate data 501, as indicated by block 704. The obtained data can include remote data 502, as indicated by block 706, The obtained data can include prior operation data 503, as indicated by block 708. The obtained data can include projected speed data 508, as indicated by block 710. The obtained data can include various other data indicative of a ride quality issue at an upcoming location at a worksite, as indicated by block 711. Further, it will be understood that one or more of the data can be continuously obtained (or updated) throughout operation 700.

At block 712, one or more other items of data are obtained (e.g., retrieved or received) by system 500 (e.g., ride quality system 215). The obtained data can include sensor data 504, as indicated by block 714. The obtained data can include threshold data 505, as indicated by block 716. The obtained data can include planned route data 506, as indicated by block 718. The obtained data can include operator control adjustment data 507, as indicated by block 720. The obtained data can include various other data 510, as indicated by block 722.

At block 724 system 215 (e.g., upcoming ride quality issue identification system 351) identifies a ride quality issue at an upcoming location at the worksite based on the obtained data. Some examples of system 215 identifying a ride quality issue at an upcoming location at the worksite are described with regard to FIG. 3. In one example, system 215 identifies a ride quality issue at an upcoming location based on data corresponding to a proximate location at the worksite (e.g., proximate data 501), as indicated by block 726. In one example, system 215 identifies a ride quality issue at an upcoming location based on data corresponding to the upcoming location (e.g., remote data 502 or prior operation data 503), as indicated by block 728. In some examples, system 215 identifies a ride quality issue based on a combination of data, as indicated by block 729. For instance, a combination of terrain characteristic values (e.g., from proximate data 501, remote data 502, or prior operation data 503) and projected machine speed values from projected machine speed data 508. In some examples, identifying a ride quality issue at an upcoming location can include system 215 (e.g., comparison logic 353) comparing the data (or a value thereof) to a threshold (or threshold value), as indicated by block 730. As previously described with regard to FIG. 3, in some examples, a threshold is provided to system 215 and in some other examples, a threshold is identified by system 215 (e.g., threshold identification system 336).

As indicated by block 731, in some examples, system 215 (e.g., confidence zone generator 352) generates a confidence zone corresponding to the identified ride quality issue at the upcoming location. Some examples of generating a confidence zone are described with regard to FIG. 3.

At block 732, system 500 (e.g., control system 214) controls the work machine based, at least, on the identified ride quality issue at the upcoming location. In some examples, at block 732, system 500 (e.g., control system 214) controls the work machine based further on the confidence zone(s) corresponding to the upcoming location.

In some examples, controlling the work machine can include system 215 (e.g., control action identification system 340) identifying one or more machine settings for controlling the work machine relative to the identified ride quality issue at the upcoming location, as indicated by block 734. Some examples of system 215 identifying one or more machine settings for controlling the work machine relative to an identified ride quality issue at an upcoming location are described with regard to FIG. 3. In some examples, identifying the one or more machine settings can include matching machine setting(s) from the obtained data, as indicated by block 736. In some examples, identifying the one or more machine settings can include scaling machine setting(s) from the obtained data, as indicated by block 738. In some examples, identifying the one or more machine settings includes implementing learning functionality, as indicated by block 740. The one or more machine settings can be identified in a variety of other ways, as indicated by block 742.

Controlling the work machine 100 can include controlling one or more controllable subsystems 216, as indicated by block 744, such as controlling one or more controllable subsystems based on the one or more machine settings identified at block 734. Controlling the work machine can, additionally, or alternatively, include controlling one or more interface mechanisms 218, as indicated by block 746. The work machine 100 can be controlled in other ways as well, as indicated by block 748.

At block 750 it is determined if the operation of work machine 100 is complete. If the operation of work machine 100 is not complete, then processing returns to block 702. If, at block 750, the operation of work machine 100 is complete, then processing ends.

The present discussion has mentioned processors and servers. In some examples, the processors and servers include computer processors with associated memory and timing circuitry, not separately shown. They are functional parts of the systems or devices to which they belong and are activated by and facilitate the functionality of the other components or items in those systems.

Also, a number of user interface displays have been discussed. The displays can take a wide variety of different forms and can have a wide variety of different user actuatable operator interface mechanisms disposed thereon. For instance, user actuatable operator interface mechanisms can include text boxes, check boxes, icons, links, drop-down menus, search boxes, etc. The user actuatable operator interface mechanisms can also be actuated in a wide variety of different ways. For instance, they can be actuated using operator interface mechanisms such as a point and click device, such as a track ball or mouse, hardware buttons, switches, a joystick or keyboard, thumb switches or thumb pads, etc., a virtual keyboard or other virtual actuators. In addition, where the screen on which the user actuatable operator interface mechanisms are displayed is a touch sensitive screen, the user actuatable operator interface mechanisms can be actuated using touch gestures. Also, user actuatable operator interface mechanisms can be actuated using speech commands using speech recognition functionality. Speech recognition can be implemented using a speech detection device, such as a microphone, and software that functions to recognize detected speech and execute commands based on the received speech.

A number of data stores have also been discussed. It will be noted the data stores can each be broken into multiple data stores. In some examples, one or more of the data stores can be local to the systems accessing the data stores, one or more of the data stores can all be located remote from a system utilizing the data store, or one or more data stores can be local while others are remote. All of these configurations are contemplated by the present disclosure.

Also, the figures show a number of blocks with functionality ascribed to each block. It will be noted that fewer blocks can be used to illustrate that the functionality ascribed to multiple different blocks is performed by fewer components. Also, more blocks can be used illustrating that the functionality can be distributed among more components. In different examples, some functionality can be added, and some can be removed.

It will be noted that the above discussion has described a variety of different systems, logic, generators, controllers, components, and interactions. It will be appreciated that any or all of such systems, logic, generators, controllers, components, and interactions can be implemented by hardware items, such as one or more processors, one or more processors executing computer executable instructions stored in memory, memory, or other processing components, some of which are described below, that perform the functions associated with those systems, logic, generators, controllers, components, or interactions. In addition, any or all of the systems, logic, generators, controllers, components, and interactions can be implemented by software that is loaded into a memory and is subsequently executed by one or more processors or one or more servers or other computing component(s), as described below. Any or all of the systems, logic, generators, controllers, components, and interactions can also be implemented by different combinations of hardware, software, firmware, etc., some examples of which are described below. These are some examples of different structures that can be used to implement any or all of the systems, logic, generators, controllers, components, and interactions described above. Other structures can be used as well.

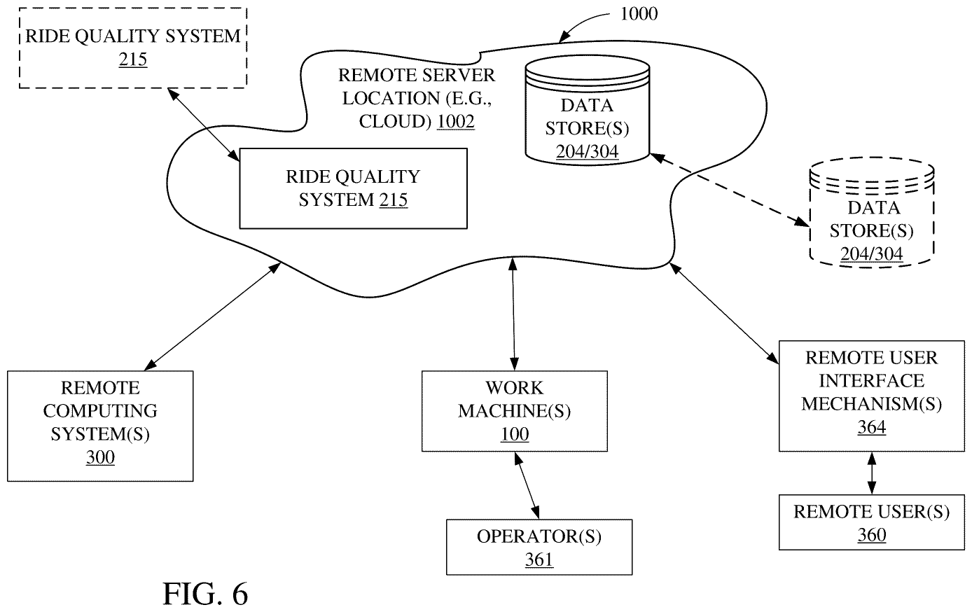

FIG. 6 is a block diagram of a remote server architecture 1000. FIG. 6, also shows one or more work machines 100, one or more remote computing systems 300, and one or more remote user interface mechanisms 364 in communication with the remote server environment. The work machines 100, remote computing systems 300, and remote user interface mechanisms 364 communicate with elements in a remote server architecture 1000. In some examples, remote server architecture 1000 provides computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network and can be accessible through a web browser or any other computing component. Software or components shown in previous figures as well as data associated therewith, can be stored on servers at a remote location. The computing resources in a remote server environment can be consolidated at a remote data center location, or the computing resources can be dispersed to a plurality of remote data centers. Remote server infrastructures can deliver services through shared data centers, even though the services appear as a single point of access for the user. Thus, the components and functions described herein can be provided from a remote server at a remote location using a remote server architecture. Alternatively, the components and functions can be provided from a server, or the components and functions can be installed on client devices directly, or in other ways.

In the example shown in FIG. 6, some items are similar to those shown in previous figures and those items are similarly numbered. FIG. 6 specifically shows that ride quality system 215, data stores 204 or data stores 304, or a combination thereof, can be located at a server location 1002 that is remote from the work machines 100, remote computing systems 300, and remote user interface mechanisms 364. Therefore, in the example shown in FIG. 6, work machines 100, remote computing systems 300, and remote user interface mechanisms 364 access systems through remote server location 1002. In other examples, various other items can also be located at server location 1002, such as various other items of system architecture 500.

FIG. 6 also depicts another example of a remote server architecture. FIG. 6 shows that some elements of previous figures can be disposed at a remote server location 1002 while others can be located elsewhere. By way of example, one or more of data store(s) 204 and 304 can be disposed at a location separate from location 1002 and accessed via the remote server at location 1002. Similarly, ride quality system 215 can be disposed at a location separate from location 1002 and accessed via the remote server at location 1002. Regardless of where the elements are located, the elements can be accessed directly by work machines 100, remote computing systems 300, and remote user interface mechanisms 364 through a network such as a wide area network or a local area network; the elements can be hosted at a remote site by a service; or the elements can be provided as a service or accessed by a connection service that resides in a remote location. Also, data can be stored in any location, and the stored data can be accessed by, or forwarded to, operators, users, or systems. For instance, physical carriers can be used instead of, or in addition to, electromagnetic wave carriers. In some examples, where wireless telecommunication service coverage is poor or nonexistent, another machine, such as a fuel truck or other mobile machine or vehicle, can have an automated, semi-automated or manual information collection system. As a mobile machine (e.g., work machine 100) comes close to the machine containing the information collection system, such as a fuel truck prior to fueling, or other mobile machine or vehicle, the information collection system collects the information from the mobile machine (e.g., work machine 100) using any type of ad-hoc wireless connection. The collected information can then be forwarded to another network when the machine containing the received information reaches a location where wireless telecommunication service coverage or other wireless coverage is available. For instance, a fuel truck, can enter an area having wireless communication coverage when traveling to a location to fuel other machines or when at a main fuel storage location. Other mobile machines or vehicles can enter an area having wireless communication coverage when traveling to other locations or when at another location. All of these architectures are contemplated herein. Further, the information can be stored on a mobile machine (e.g., work machine 100) until the mobile machine enters an area having wireless communication coverage. The mobile machine (e.g., work machine 100), itself, can send the information to another network.

It will also be noted that the elements of previous figures, or portions thereof, can be disposed on a wide variety of different devices. One or more of those devices can include an on-board computer, an electronic control unit, a display unit, a server, a desktop computer, a laptop computer, a tablet computer, or other mobile device, such as a palm top computer, a cell phone, a smart phone, a multimedia player, a personal digital assistant, etc.

In some examples, remote server architecture 1000 can include cybersecurity measures. Without limitation, these measures can include encryption of data on storage devices, encryption of data sent between network nodes, authentication of people or processes accessing data, as well as the use of ledgers for recording metadata, data, data transfers, data accesses, and data transformations. In some examples, the ledgers can be distributed and immutable (e.g., implemented as blockchain).

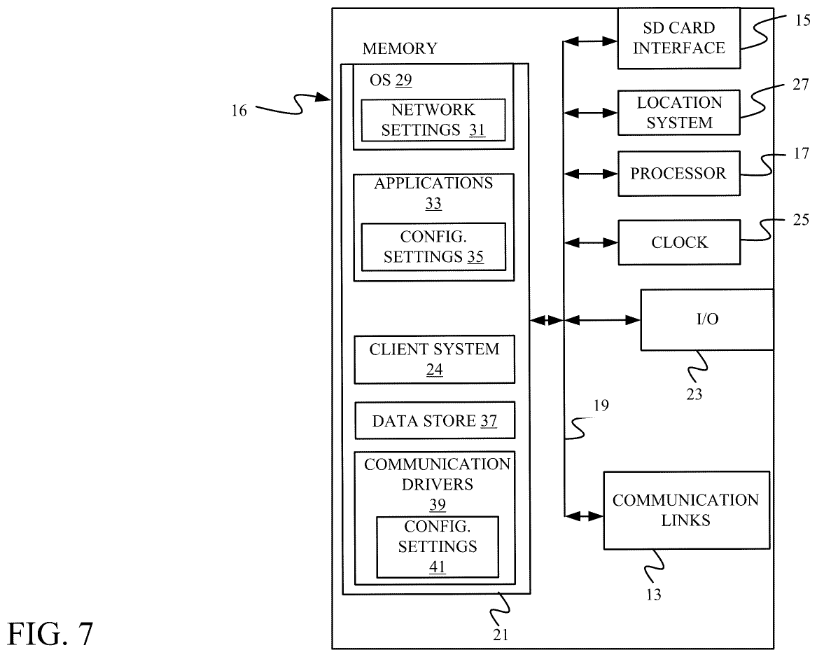

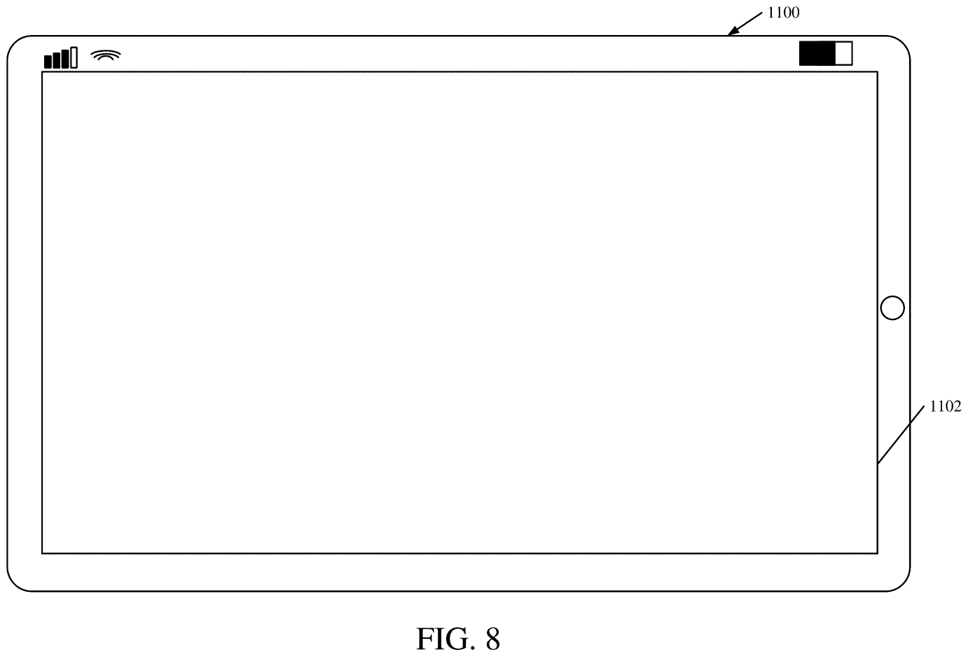

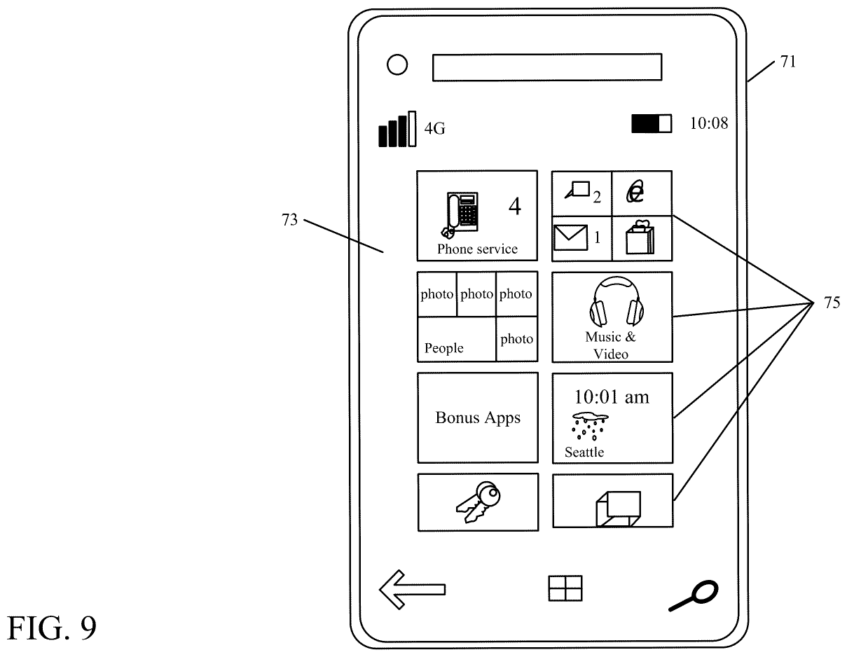

FIG. 7 is a simplified block diagram of one illustrative example of a handheld or mobile computing device that can be used as a user's or client's handheld device 16, in which the present system (or parts of it) can be deployed. For instance, a mobile device can be deployed in the operator compartment of a mobile machine (e.g., work machine 100) or can be communicably coupled to a mobile machine (e.g., work machine 100) for use in generating, processing, or displaying the outputs (e.g., 360) discussed above. FIGS. 8 and 9 are examples of handheld or mobile devices.

FIG. 7 provides a general block diagram of the components of a client device 16 that can run some components shown in previous figures, that interacts with them, or both. In the device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from other figures) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, client system 24, data store 37, communication drivers 39, and communication configuration settings 41. Memory 21 can include all types of tangible volatile and non-volatile computer-readable memory devices. Memory 21 can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

FIG. 8 shows one example in which device 16 is a tablet computer 1100. In FIG. 8, computer 1100 is shown with user interface display screen 1102. Screen 1102 can be a touch screen or a pen-enabled interface that receives inputs from a pen or stylus. Tablet computer 1100 can also use an on-screen virtual keyboard. Of course, computer 1100 can also be attached to a keyboard or other user input device through a suitable attachment mechanism, such as a wireless link or USB port, for instance. Computer 1100 can also illustratively receive voice inputs as well.

FIG. 9 is similar to FIG. 8 except that the device is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

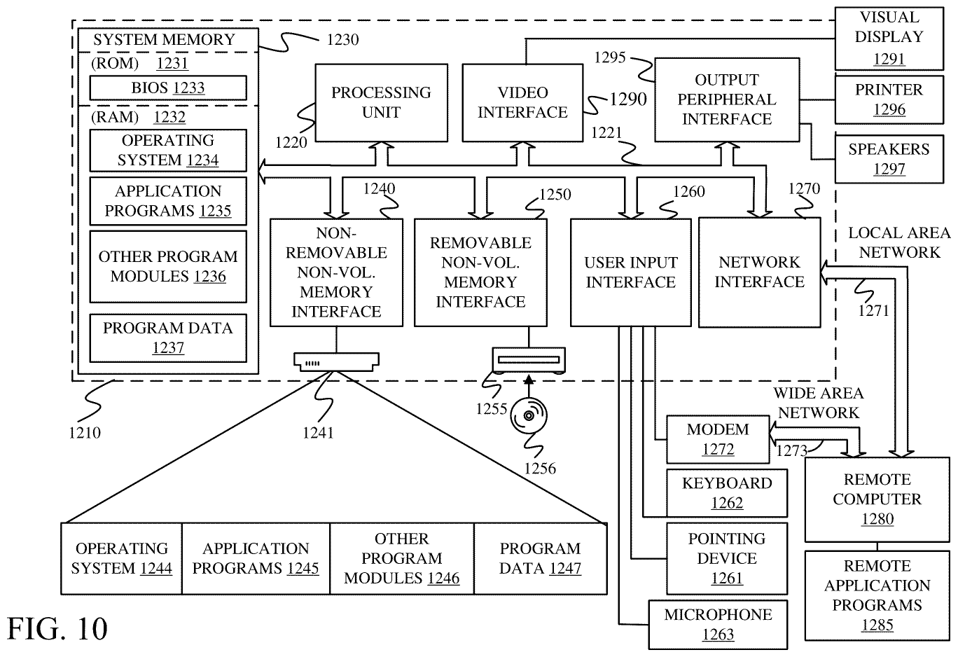

FIG. 10 is one example of a computing environment in which elements of previous figures described herein can be deployed. With reference to FIG. 10, an example system for implementing some embodiments includes a computing device in the form of a computer 1210 programmed to operate as discussed above. Components of computer 1210 can include, but are not limited to, a processing unit 1220 (which can comprise processors or servers from previous figures), a system memory 1230, and a system bus 1221 that couples various system components including the system memory to the processing unit 1220. The system bus 1221 can be any of several types of bus structures including a memory bus or memory controller, a peripheral bus, and a local bus using any of a variety of bus architectures. Memory and programs described with respect to previous figures described herein can be deployed in corresponding portions of FIG. 10.

Computer 1210 typically includes a variety of computer readable media. Computer readable media can be any available media that can be accessed by computer 1210 and includes both volatile and nonvolatile media, removable and non-removable media. By way of example, and not limitation, computer readable media can comprise computer storage media and communication media. Computer storage media is different from, and does not include, a modulated data signal or carrier wave. Computer readable media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1210. Communication media can embody computer readable instructions, data structures, program modules or other data in a transport mechanism and includes any information delivery media. The term “modulated data signal” means a signal that has one or more of its characteristics set or changed in such a manner as to encode information in the signal.

The system memory 1230 includes computer storage media in the form of volatile and/or nonvolatile memory or both such as read only memory (ROM) 1231 and random access memory (RAM) 1232. A basic input/output system 1233 (BIOS), containing the basic routines that help to transfer information between elements within computer 1210, such as during start-up, is typically stored in ROM 1231. RAM 1232 typically contains data or program modules or both that are immediately accessible to and/or presently being operated on by processing unit 1220. By way of example, and not by limitation, FIG. 10 illustrates operating system 1234, application programs 1235, other program modules 1236, and program data 1237.

The computer 1210 can also include other removable/non-removable volatile/nonvolatile computer storage media. By way of example only, FIG. 10 illustrates a hard disk drive 1241 that reads from or writes to non-removable, nonvolatile magnetic media, an optical disk drive 1255, and nonvolatile optical disk 1256. The hard disk drive 1241 is typically connected to the system bus 1221 through a non-removable memory interface such as interface 1240, and optical disk drive 1255 are typically connected to the system bus 1221 by a removable memory interface, such as interface 1250.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), quantum computers, etc.

The drives and their associated computer storage media discussed above and illustrated in FIG. 10, provide storage of computer readable instructions, data structures, program modules and other data for the computer 1210. In FIG. 10, for example, hard disk drive 1241 is illustrated as storing operating system 1244, application programs 1245, other program modules 1246, and program data 1247. Note that these components can either be the same as or different from operating system 1234, application programs 1235, other program modules 1236, and program data 1237.

A user can enter commands and information into the computer 1210 through input devices such as a keyboard 1262, a microphone 1263, and a pointing device 1261, such as a mouse, trackball or touch pad. Other input devices (not shown) can include a joystick, game pad, satellite dish, scanner, or the like. These and other input devices are often connected to the processing unit 1220 through a user input interface 1260 that is coupled to the system bus, but can be connected by other interface and bus structures. A visual display 1291 or other type of display device is also connected to the system bus 1221 via an interface, such as a video interface 1290. In addition to the monitor, computers can also include other peripheral output devices such as speakers 1297 and printer 1296, which can be connected through an output peripheral interface 1295.

The computer 1210 is operated in a networked environment using logical connections (such as a controller area network—CAN, local area network—LAN, or wide area network WAN) to one or more remote computers, such as a remote computer 1280.

When used in a LAN networking environment, the computer 1210 is connected to the LAN 1271 through a network interface or adapter 1270. When used in a WAN networking environment, the computer 1210 typically includes a modem 1272 or other means for establishing communications over the WAN 1273, such as the Internet. In a networked environment, program modules can be stored in a remote memory storage device. FIG. 10 illustrates, for example, that remote application programs 1285 can reside on remote computer 1280.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of the claims.

What is claimed is:

1. A system comprising:
one or more processors; and
memory storing instructions, executable by the one or more processors, that, when executed by the one or more processors, configure the one or more processors to:
obtain data indicative of a ride quality issue at an upcoming location at a worksite at which a work machine performs a current operation;
identify a ride quality issue at the upcoming location at the worksite based on the data; and
control the work machine based, at least, on the ride quality issue at the upcoming location at the worksite.

2. The system of claim 1, wherein the data comprises one of: (i) proximate data corresponding to a location at the worksite different than the upcoming location; (ii) prior operation data generated during a prior operation at the worksite; or (iii) remote data generated by a system remote from the worksite.

3. The system of claim 2, wherein the work machine comprises a first work machine having a first machine type and wherein the prior operation is conducted by a second work machine having a second machine type, different than the first machine type.

4. The system of claim 2, wherein the data indicates one or more of: (i) machine speed; (ii) machine bouncing; or (iii) a terrain characteristic.

5. The system of claim 1, wherein the data is generated by one or more sensors of the work machine and corresponds to a location at the worksite different than the upcoming location.

6. The system of claim 1, wherein the instructions, when executed by the one or more processors, further configure the one or more processors to:
compare the data to a threshold; and
identify the ride quality issue at the upcoming location at the worksite based on comparison of the data to the threshold.

7. The system of claim 6, wherein the threshold is identified during the current operation based on operator control adjustment data corresponding to a location at the worksite different than the upcoming location, the operator control adjustment data indicating an operator adjustment to the work machine.

8. The system of claim 1, wherein the data includes a first machine setting value and wherein the instructions when executed by the one or more processors, further configure the one or more processors to:
identify a second machine setting value based on the first machine setting value, the second machine setting value matching the first machine setting value; and
control the work machine based, at least, on the second machine setting value.

9. The system of claim 1, wherein the data includes a first machine setting value and wherein the instructions when executed by the one or more processors, further configure the one or more processors to:
scale the first machine setting value to identify a second machine setting value; and
control the work machine based, at least, on the second machine setting value.

10. The system of claim 1, wherein the instructions when executed by the one or more processors, further configure the one or more processors to control the work machine by controlling one or more of: (i) an interface mechanism of the work machine to generate a presentation; (ii) a propulsion subsystem of the work machine to change a speed of the work machine; (iii) an actuator of the work machine to adjust a position of an implement of the work machine; or (iv) an actuator of the work machine to adjust a biasing force applied to an implement of the work machine.

11. A computer-implemented method of controlling an agricultural work machine comprising:
obtaining data indicative of a ride quality issue at an upcoming location at a worksite at which the work machine performs a current operation;
identifying a ride quality issue corresponding to the upcoming location at the worksite based on the data;
controlling the work machine based, at least, on the ride quality issue corresponding to the upcoming location at the worksite.

12. The computer-implemented method of claim 11, wherein obtaining the data comprises obtaining one or more of: (i) proximate data corresponding to a location at the worksite different than the upcoming location; (ii) prior operation data generated during a prior operation at the worksite; or (iii) remote data generated by a system remote from the worksite.

13. The computer-implemented method of claim 11, wherein obtaining the data comprises obtaining data indicative one or more of: (i) machine speed; (ii) machine bouncing; or (iii) a terrain characteristic.

14. The computer-implemented method of claim 13, wherein obtaining the data comprises obtaining sensor data corresponding to a location of the worksite different than the upcoming location and generated by one or more sensors of the work machine.

15. The computer-implemented method of claim 11, wherein controlling the work machine comprises one or more of: (i) controlling an interface mechanism of the work machine to generate a presentation; (ii) controlling a propulsion subsystem of the work machine to change a speed of the work machine; (iii) controlling an actuator of the work machine to adjust a position of an implement of the work machine; or (iv) controlling an actuator of the work machine to adjust a biasing force applied to an implement of the work machine.

16. An agricultural work machine comprising:
one or more processors; and
memory storing instructions, executable by the one or more processors, that, when executed by the one or more processors, configure the one or more processors to:
obtain data indicative of a ride quality issue corresponding to an upcoming location at a worksite at which the work machine performs a current operation;
identify a ride quality issue corresponding to the upcoming location at the worksite based on the data; and
control the work machine based, at least, on the ride quality issue corresponding the upcoming location at the worksite.

17. The work machine of claim 16, wherein the data comprises one or more of: (i) proximate data corresponding to a location at the worksite different than the upcoming location; (ii) prior operation data generated during a prior operation at the worksite; or (iii) remote data generated by a system remote from the worksite.

18. The work machine of claim 16, the data is indicative one or more of: (i) machine speed; (ii) machine bouncing; or (iii) a terrain characteristic.

19. The work machine of claim 18, wherein the data comprises sensor data corresponding to a location of the worksite different than the upcoming location and generated by one or more sensors of the work machine.

20. The work machine of claim 16, wherein the instructions when executed by the one or more processors, further configure the one or more processors to control the work machine by controlling one or more of: (i) an interface mechanism of the work machine to generate a presentation; (ii) a propulsion subsystem of the work machine to change a speed of the work machine; (iii) an actuator of the work machine to adjust a position of an implement of the work machine; or (iv) an actuator of the work machine to adjust a biasing force applied to an implement of the work machine.
